(19) United States
(12) Patent Application Publication
(10) Pub. No.: US 2024/0001465 A1
(43) Pub. Date: Jan. 4, 2024

(54) A TWO-PART RAIL SAW ASSEMBLY

(71) Applicant: Glenton William REBELLO, Wynberg, Sandton (ZA)

(72) Inventor: Glenton William REBELLO, Wynberg, Sandton (ZA)

(21) Appl. No.: 18/252,991

(22) PCT Filed: Nov. 15, 2021
(86) PCT No.: PCT/IB2021/060547

§ 371 Date: May 15, 2023

(30) Foreign Application Priority Data
Nov. 16, 2020 (ZA) 2020/07115

(51) Int. Cl. B23D 45/00; B23D 47/08; E01B 31/04

(52) U.S. Cl. CPC B23D 45/003; B23D 45/006; B23D 47/08; E01B 31/04

(57) ABSTRACT

A two-part rail saw assembly includes a clamp part and a saw part. The clamp part includes a clamp mechanism configured to clamp to a rail to be cut and a first connection interface coupled to the clamp mechanism. The saw part includes a second connection interface complemental to the first connection interface, the first and second connection interfaces configured to fixedly and positively interconnect, thereby to connect and fix the saw part relative to the clamp part. The saw part also includes a circular saw blade rotatably mounted to a saw hub, the saw hub being displaceably mounted relative to the second connection interface. The saw part further includes a feed mechanism configured to guide and displace the saw hub, and hence the saw blade, through a cutting path relative to the second connection interface, and thus relative to the clamp part when the parts are interconnected, and thus relative to the rail when the clamp mechanism is clamped thereto.

### FIELD OF INVENTION

This invention relates generally to cutting of railway or train track rails and specifically to a two-part rail saw assembly for cutting rails.

### BACKGROUND OF INVENTION

During railway (train) track installation or maintenance, it is at times necessary to cut through a rail. The Applicant has a need for a portable rail cutter which achieves this task with high precision/accuracy in a short time, whilst maintaining operator safety. To improve portability, the weight of this saw should be as low as possible.

The Applicant currently produces a TCT (tungsten carbide tipped) one-piece rail saw; however, it is heavy (40-50 kg). A known solution to this weight problem for different machines is to break the machine into smaller sub-assemblies during transport which connect together non-permanently during use. Each sub-assembly should weigh less than 25 kg for easy adoption on London Underground (LUL) and other rail networks by demonstrating compliance with ISO 11228-1:2003. However, this modular approach does present some technical challenges specifically for TCT rail saws.

For optimal TCT rail cutting, as few teeth as possible must contact the rail at any one time. This requires accurate positioning of the rail relative to the blade. Deviation from the correct position by as little as 5-10 mm has a noticeable impact on saw performance and in extreme cases may entirely prevent a rail from being cut. Additionally, any float or flexibility between the blade and rail causes vibration which may damage tungsten teeth of the blade—leading to a similar impediment to performance. Lastly, rigid guards should be placed around the blade, wherever practicable, to catch sparks; if the blade movement is repeatable/predictable, a larger area of the blade can be more precisely guarded by a smaller guard than if the movement is unpredictable.

### SUMMARY OF INVENTION

Accordingly, the invention provides a two-part rail saw assembly which includes:
a clamp part including:
   a clamp mechanism configured to clamp to a rail to be cut; and
   a first connection interface coupled to the clamp mechanism; and
a saw part including:
   a second connection interface complemental to the first connection interface, the first and second connection interfaces configured to fixedly and positively interconnect, thereby to connect and fix the saw part relative to the clamp part;
   a circular saw blade rotatably mounted to a saw hub, the saw hub being displaceably mounted relative to the second connection interface; and
   a feed mechanism configured to guide and displace the saw hub, and hence the saw blade, through a cutting path relative to the second connection interface, and thus relative to the clamp part when the parts are interconnected, and thus relative to the rail when the clamp mechanism is clamped thereto.

The saw hub may be mounted (directly or indirectly) to the second connection interface via a saw arm. The saw arm may be hingedly connected/mounted at one end to the saw hub and/or mounted at the other end to a part of the second connection interface. The saw arm may define or control the cutting path. The cutting path may be a cutting arc.

The feed mechanism may interconnect (1) the saw hub or saw arm and (2) the second connection interface. The feed mechanism may include an actuator. The actuator may be a hand-operable actuator. The actuator may be in the form of a handle, wheel, lever, crank, or similar mechanical actuator. The feed mechanism may be connected between both the saw hub/saw arm and the second connection interface.

The feed mechanism may be hingedly or pivotally connected to the second connection interface. The hinged connections of the feed mechanism and the saw arm to the second connection interface may be transversely offset, or not co-axial, or off-axis.

The feed mechanism may include a threaded feed shaft co-operable with a threaded channel, socket, or bush on the saw hub or saw arm. Rotating the feed shaft of the feed mechanism may cause the saw hub to travel linearly along the feed shaft and correspondingly to be displaced along the cutting path.

The connection interfaces may be configured for a sliding interconnection. To this end, the connection interfaces may include complemental sliding formations, e.g., male and female dovetail formations, tongue and groove formations, channel and projection formations, etc. One or both connection formations may include a lip, ridge, or other stopper formation to limit an extent of sliding when the two connection interfaces are fully interconnected.

The connection interfaces may define a locking formation, e.g., a pin and matched socket, or lug and recess, etc., to accommodate the pin, to prevent sliding and lock the connection interfaces together. Further, the connection interfaces may include a mechanical compression formation configured to urge, compress, or force the connection interfaces into locked and rigid engagement.

A guard may be mounted over part of the saw blade. The guard may be mounted to the saw hub. An additional fixed guard may be mounted to the clamp, the two guards (the hub-mounted and clamp-mounted) may cooperate with each other to create a spark-tight connection. The fixed guard may be fitted with a shavings collection tray.

The feed mechanism may be automated. To this end, the feed mechanism may include an actuator in the form of a motor. The motor may be instead of, or in addition to, a hand-operable actuator.

The feed mechanism may include a control module to provide a control signal to the motor to actuate the motor. The control module may be configured to generate the control signal in response to receipt of a user command. The feed mechanism may include one or more of:
a user input configured to receive the user command; and/or
a communication arrangement configured to receive the user command from a remote device.

The communication arrangement may be a wireless communication arrangement (e.g., Bluetooth, RF, WiFi, cellular, etc.) and the remote device may be a mobile or portable electronic device.

The rail saw assembly may include an electric motor drivingly connected to the saw blade and a battery configured to be connected to the electric motor thereby to drive the saw blade.

Depending on the implementation and weight restrictions/requirements of the parts, the battery may be provided in, or integrated with, either of the clamp part or the saw part, or in a third part, namely a battery part. Accordingly, although the rail saw is defined as a two-part rail saw, this means that there must be at least two parts but there may be more than two (e.g., three) parts. The battery part maybe mechanically attachable to the clamp part or the saw part and may be electrically connectable to the electric motor.

The rail saw may include a battery controller coupled to the battery (which may be the same component as the control module used to control the motor of the feed mechanism, if present.) The battery controller may be configured to receive a user input (e.g., start or stop) from an input interface which may be coupled to the battery controller.

### BRIEF DESCRIPTION OF DRAWINGS

The invention will now be further described, by way of example, with reference to the accompanying diagrammatic drawings.

In the drawings:

FIG. 1 shows an exploded front three-dimensional view of a first embodiment of a two-part rail saw assembly, in accordance with the invention;

FIG. 2 shows an exploded rear three-dimensional view of the two-part rail saw assembly of FIG. 1;

FIG. 3 shows a front three-dimensional view of a clamp part of the two-part rail saw assembly of FIG. 1, clamped to a rail;

FIG. 4 shows a rear three-dimensional view of the two-part rail saw assembly of FIG. 1, with the parts interconnected and clamped to a rail;

FIG. 5 shows a front three-dimensional view of the two-part rail saw assembly of FIG. 4, with the parts interconnected, and saw disengaged;

FIG. 6 shows a front three-dimensional view of the two-part rail saw assembly of FIG. 5, with the parts interconnected, and saw engaged;

FIG. 7 shows a front three-dimensional view from another angle of the two-part rail saw assembly of FIG. 6;

FIG. 8 shows a three-dimensional view of a second embodiment of a two-part rail saw assembly, in accordance with the invention;

FIG. 9 shows a three-dimensional view of the saw part of the rail saw assembly of FIG. 8;

FIG. 10 shows an enlarged view of a feed mechanism of the rail saw assembly of FIG. 8;

FIG. 11 shows an axial-sectional view of the feed assembly of the rail saw assembly of FIG. 10;

FIG. 12 shows a side view of the saw part of FIG. 9 in a retracted position;

FIG. 13 shows a side view of the saw part of FIG. 9 in an extended position; and

FIG. 14 shows an operator using the feed mechanism of FIG. 10;

FIG. 15 shows an exploded, three-dimensional view of a third embodiment of a rail saw assembly, in accordance with the invention; and

FIG. 16 shows an assembled, three-dimensional view of the rail saw assembly of FIG. 15.

### DETAILED DESCRIPTION OF EXAMPLE EMBODIMENT

The following description of an example embodiment of the invention is provided as an enabling teaching of the invention. Those skilled in the relevant art will recognise that changes can be made to the example embodiment described, while still attaining the beneficial results of the present invention. It will also be apparent that some of the desired benefits of the present invention can be attained by selecting some of the features of the example embodiment without utilising other features. Accordingly, those skilled in the art will recognise that modifications and adaptations to the example embodiment are possible and can even be desirable in certain circumstances and are a part of the present invention. Thus, the following description of the example embodiment is provided as illustrative of the principles of the present invention and not a limitation thereof.

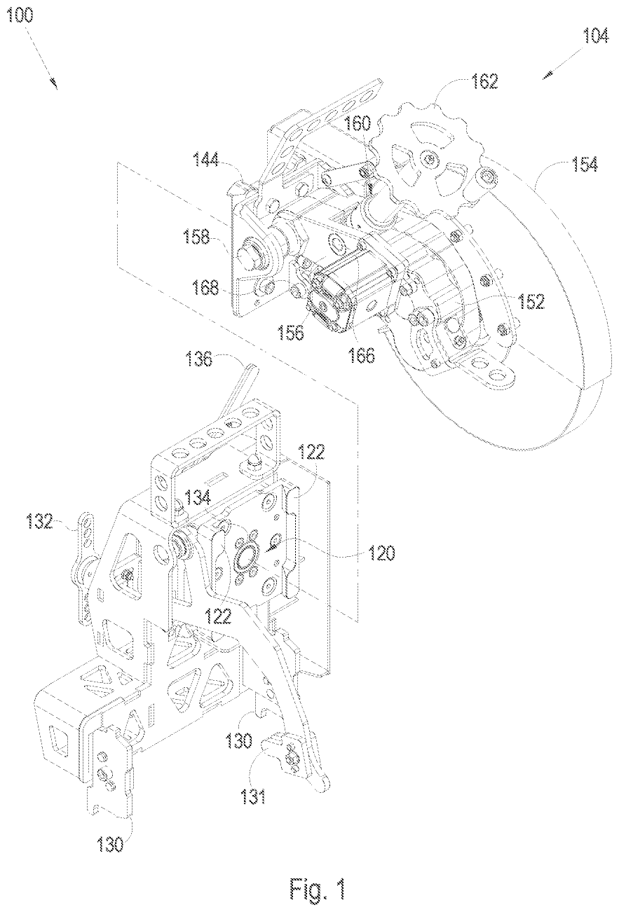

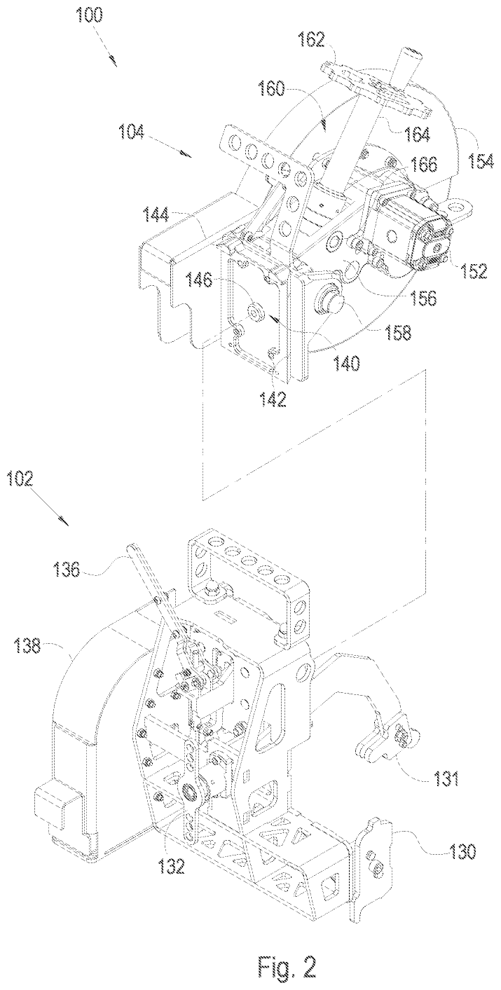

FIGS. 1-2 illustrate a first embodiment of a two-part rail saw assembly 100, in accordance with the invention, which comprises a clamp part 102 and a saw part 104. These two parts 102, 104 are separable or connectable, as may be required for storage or in use; this is one of the important features of the invention as will become apparent from the description below. Each of the parts 102, 104 is entirely separable from the other and may even be transported or stored separately.

Each of the parts 102, 104 has a connection interface 120, 140 to interconnect to the other; more specifically, a first connection interface 120 (FIG. 1) is provided at a front of the clamp part 102 and a complemental, second connection interface 140 (FIG. 2) is provided at a rear of the saw part 104. A significant characteristic of the connection interfaces 120, 140 is that they interconnect rigidly and fixedly; that is, they do not provide a jointed connection or a connection that is displaceable when sawing/cutting.

There may be various mechanical design choices to achieve such a rigid connection, but in this embodiment, the connection interfaces 120, 140 are in the form of dovetail or dovetail-like structures. More specifically, the first connection interface 120 defines female dovetail formations 122 and the second connection interface 140 defines corresponding male dovetail formations 142. The dovetail formations 140, 142 permit a sliding connection of the saw part 104 with the clamp part 102. More specifically, the clamp part 102 may be held in place (e.g., clamped to a rail) and the saw part 104 is positioned above the clamp part 102 with the respective dovetail formations 122, 142 vertically aligned. The saw part 104 is guided downwardly so that the connection interfaces 120, 140 slide alongside each other and the dovetail formations 122, 142 mate.

A rearwardly projecting lip 144 is provided at a top of the second connection interface 140. The lip 144 serves as a stop to limit an extent of downward slidability of the saw part 104 by abutting with a top of the first connection interface 120 when fully engaged. In other words, the second connection interface 140 of the saw part 104 is slid into the first connection interface 120 of the clamp part 102 until the lip 144 abuts and bears against the top of the first connection formation 120.

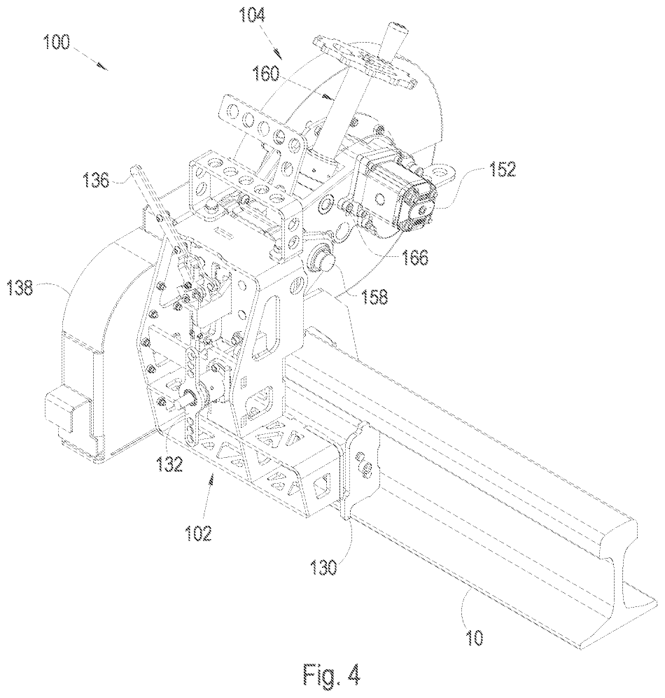

The saw assembly 100 also includes a locking arrangement 134, 136, 146 provided on both parts 102, 104. A raised circular locating lug 146 is provided at a centre of the second connection interface 140. A complemental compression mechanism 134, with a recess matched to the lug 146, is provided at a centre of the first connection interface 120. A lever 136, arranged at a rear of the clamp part 102 (see FIG. 4), is connected to the compression mechanism 134 by means of a mechanical linkage (not illustrated).

Actuating (turning) the lever 136 urges the compression mechanism 134 forwards. When the two connection interfaces 120, 140 are engaged, the compression mechanism 134 engages the lug 146 and seats the lug 146 snugly within the recess, thereby precisely locating the two connection interfaces 120, 140, and hence the two parts 102, 104, relative to each other. Further, the compression mechanism 134 is urged or compressed against the second connection interface 140 to lock it firmly and accurately in place. The lever 136, via the mechanical linkage, converts a 25 kg applied force into a ±1000 kg compression force. This compression force causes the tapers of the male and female dovetail formations 122, 142 to self-align with each other. This requires a single movement and needs no judgement on behalf of the user as to how much force to apply.

Turning to the clamp part 102, it includes a clamp mechanism having three clamp elements or jaws 130, 131 arranged at laterally spaced apart intervals. One of the clamp elements 131 is displaceable and the others 130 are fixed. The clamp mechanism has a clamp actuator 132 provided at a rear of the clamp part 102. The clamp actuator 132 is in the form of a rotary handle and is mechanically linked to the displaceable clamp element 131, e.g., via a thread and nut arrangement.

The clamp part 102 also has a shavings collection tray 138 attached thereto. The shavings collection tray 132 is provided behind a cutting zone to catch shavings, debris, and other material likely to be cast off during cutting.

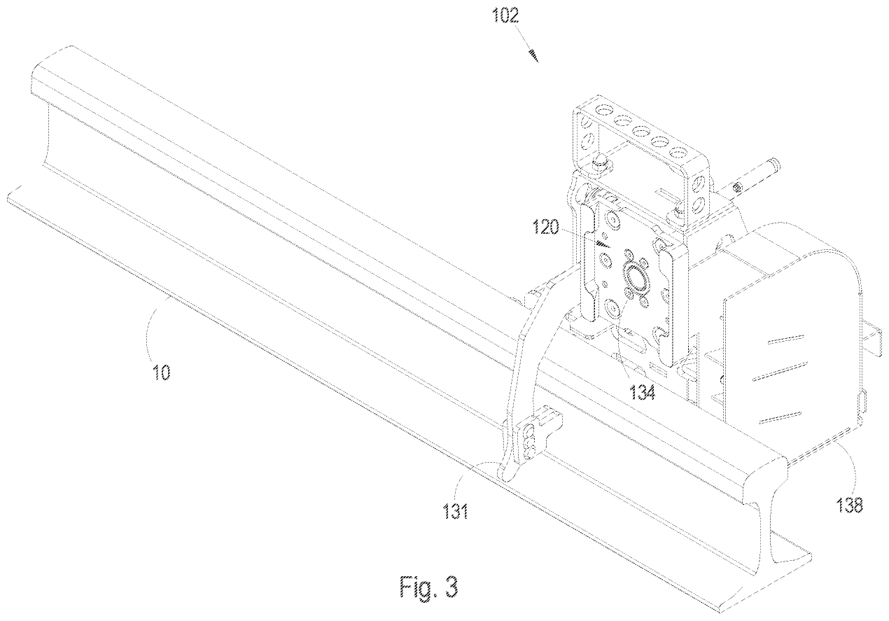

FIGS. 3-4 illustrate the clamp part 102 mounted to a rail 10. Turning the clamp actuator 132 urges the displaceable element 131 inwardly (or outwardly, to unclamp) which causes the clamp part 102 to firmly engage the rail 10 with the fixed clamp elements 130 on one side of the rail 10 and with the displaceable clamp element 131 on the other side of the rail 10. Tapers on the fixed clamp elements 130 self-align the clamp part 102 against matching tapers on the rail 10. The design of this clamp element 130 may dictate relative position between the rail 10 and clamp element 102. In addition, the fixed clamp elements 130 may be modular, being removable and replaceable, such that each rail size has a corresponding clamp element 130.

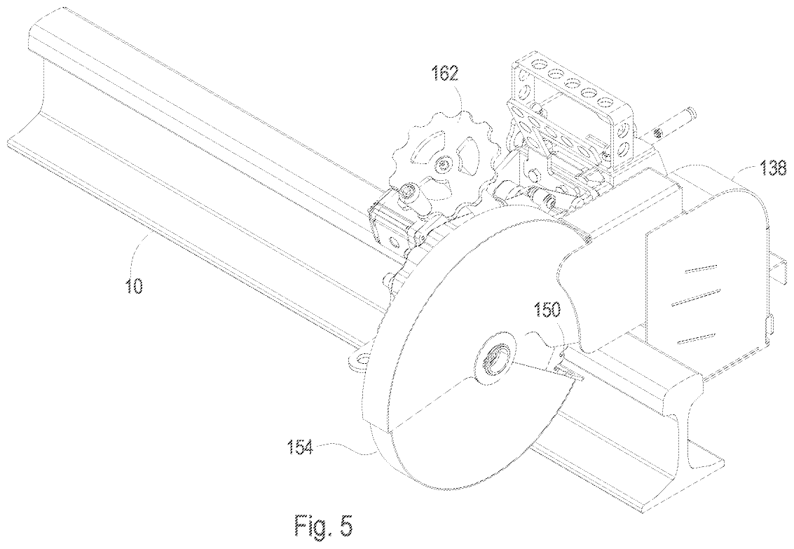

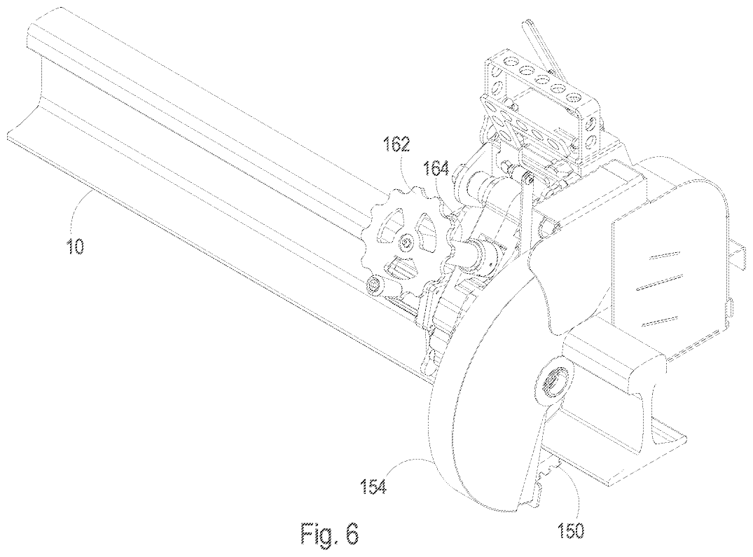

Turning now to the saw part 104, a saw blade 150 (partially illustrated in FIGS. 5-6) is rotatably mounted to a saw hub 152. The saw blade 150 is generally concealed by a guard 154. The guard 154 may be configured similarly to those of woodworking circular saws in which part of it is automatically retracted when the saw blade 150 is displaced towards a workpiece. The saw hub 152 is mounted via a saw arm 156 to a rear part of the second connection interface 140 by means of a first pivoted or hinged connection 158 (refer to FIGS. 1, 2, 7). The first pivoted connection 158 permits the entire saw hub 152 and blade 150 to hinge and pivot relative to the second connection interface 140 and thus relative to the clamp part 102.

An important aspect of the rail saw assembly 100 is a feed mechanism 160 configured to displace the saw blade 150 in a controlled and repeatable fashion. The feed mechanism 160 is configured to translate a rotational input from the user into a linear or arcuate displacement of the saw blade 150. The feed mechanism 160 comprises a feed actuator 162 provided by a rotary fluted wheel with a crank handle projecting outwardly therefrom.

A feed shaft assembly 164 extends from the wheel 162 and is pivotally or hingedly connected at two points: namely to the saw arm 156 by means of a second pivoted or hinged connection 166 and to the rear part of the second connection interface 120 by means of a third pivoted or hinged connection 168. The feed shaft assembly 164 includes two telescopically extendable/retractable shaft portions (an outer shaft portion, visible and an inner shaft portion, not readily visible) which are threadedly engaged to each other, but only one (the outer shaft portion) of which is free to rotate. The outer shaft portion is fixed to the wheel 162.

Accordingly, rotating the wheel 162 causes rotation of the outer shaft portion which—due to the threaded engagement—causes it to travel longitudinally telescopically relative to the inner shaft portion. This telescopic action translates to an inward or outward force exerted on the saw arm 156. Importantly, the first and third pivoted connections 158, 168 are not coaxial—they are off-axis (FIG. 1)—which means that displacing the saw arm 156 linearly along the feed shaft assembly 164 causes the saw arm 156, and hence the saw hub 152, to pivot about the first pivoted connection 158. A full rotation of the feed wheel 162 causes the saw arm 156 to be displaced by one thread width which may be a few mm. Accordingly, the feed wheel 162 provides relatively slow but controlled and firm displacement of, ultimately, the saw blade 150.

The saw assembly 100 may well include various other features like handles, structural support members, fasteners, etc. The saw hub 152 includes a power socket to receive a power source to power a motor contained in the hub 152 to rotate the saw blade 150. The motor may be a hydraulic motor, pneumatic motor, electric motor (mains or battery, VAC or VDC), or combustion engine. In this illustrated embodiment, the motor is a hydraulic motor, and the power source would therefore be a hydraulic power source. The motor (of whatever type) may drive the saw blade 150 via a reduction gearbox.

The example will be further described in use. A user—for example, a rail maintenance man—wishes to maintain, repair, or replace a train rail 10 in situ. This requires cutting the rail 10 at a point. The user has the two parts 102, 104 nearby, for example in his maintenance vehicle. Each part only weights 20-25 kg, so he can carry them individually relatively easily. He retrieves them, one by one, and carries them individually to the rail 10 to be cut.

First, he picks up the clamp part 102 and physically manoeuvres it such that the clamp elements 130, 131 are on either side of the rail 10. He proceeds to turn the clamp actuator 132 to displace the displaceable clamp element 131 inwardly, to tighten the clamp part 102 around the rail 10. This may be provided by a positive fit and/or frictional engagement. Once sufficiently tight, he can leave the clamp actuator 132 (it is self-locking and will not unwind by itself) and move to the next step.

By way of development, the clamp actuator 132 may be fitted with a load limiting mechanism. Such a load limiting mechanism may disengage the clamp actuator 132 from the clamp elements 130, 131 (and give an audible click) once the appropriate clamping force is achieved (similar to a torquing mechanism in a torque wrench). This load limiting mechanism may be configured to slip when a predefined amount of tension is applied to the clamp elements 130, 131 (as opposed to the torque applied to the clamp actuator 132) This means that irrespective of whether the clamp mechanism is lubricated/unlubricated, worn/new, a repeatable clamping force may always be applied.

The user lifts the saw part 104 above the clamped clamp part 102 and vertically aligns the respective connection interfaces 120, 140. He slowly lowers the saw part 104 so that its male dovetail formations 142 engage the female dovetail formations of the clamp part 102. He then continues to lower it, sliding the respective dovetail formations 122, 142 together until the lip 144 abuts the top of the first connection interface 120, indicating full interconnection.

He then locks the parts 102, 104 together. This is achieved by turning the lever 136 about a quarter turn. The underlying mechanical linkage provides mechanical advantage to move the compression mechanism 134 outwardly a short distance to engage with the matched lug 146 on the other interface 140. This prevents any separation of the two parts 102, 104 during sawing; in fact, the two parts 102, 104 are now rigidly and non-displaceably interconnected and can only be separated again by releasing the locking mechanism 134, 136, 146. The assembly 100 is now clamped and interconnected (FIGS. 4-5).

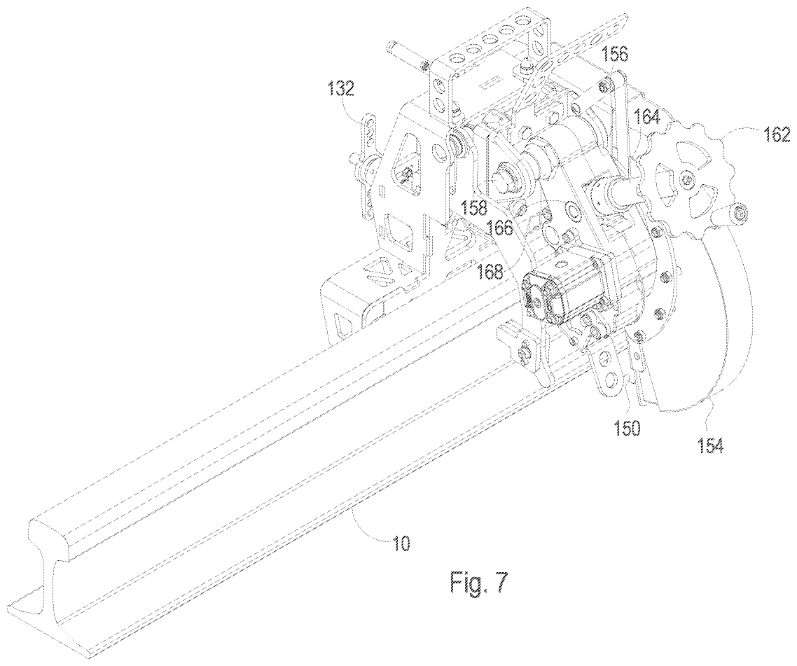

The assembly 100 is ready for sawing (see FIGS. 6-7). The user plugs in the hydraulic cable (not illustrated) and the saw blade 150 is driven and spins; the motor provides desired speed/torque characteristics. The user slowly rotates the feed actuator 162 either by grasping and turning the fluted wheel or by grasping and cranking the crank handle. He may be wearing workers gloves so he may choose the option which best suits the situation. As he turns the feed actuator 162, the feed shaft assembly 164 telescopically retracts between the second and third pivoted connections 166, 168. This causes the saw arm 156 to be displaced and tilt gradually downwardly as it pivots about the first pivoted connection 158.

The guard 154 is pulled back as the saw blade 150 is displaced towards the rail (note the transition from FIG. 5 to FIG. 6). The saw blade 150 contacts the rail 10 and begins cutting it. The user continues to turn the feed actuator 162 which continues to displace the saw blade 150 inwardly, continuing cutting. The guard 154 is closely positioned over the saw blade 150, which is possible because the displacement of the saw blade 150 is so controlled, in order to block any sparks that may be fired forwardly towards the user.

The shavings collection tray 138 has been precisely arranged behind a cutting zone of the saw blade 150 to catch shavings or particles from the rail 10 during cutting. This enables a safer and cleaner working environment. The shavings collection tray 138 can be emptied when appropriate. The saw guard 154 may be configured to direct shavings towards the shavings collection tray 138.

Once finished with a first cut, the user can turn the motor off and then rapidly turn the feed actuator 162 in reverse. The rail 10 has then been cut safely and precisely. If further cuts are required, the user can disconnect and unclamp (by following the reverse procedure for connection and clamping), reposition, clamp, and connect again.

This may even be possible without disconnecting the two parts 102, 104, although disconnection may be preferred for easier handling. The saw part 104 may optionally be fitted with an end stop for accurate positioning, to remove precise (and thin) slivers from the end of the rail 10, if necessary. Once finished entirely, the user disconnects, unclamps, and removes the parts 102, 104. He may then restow them.

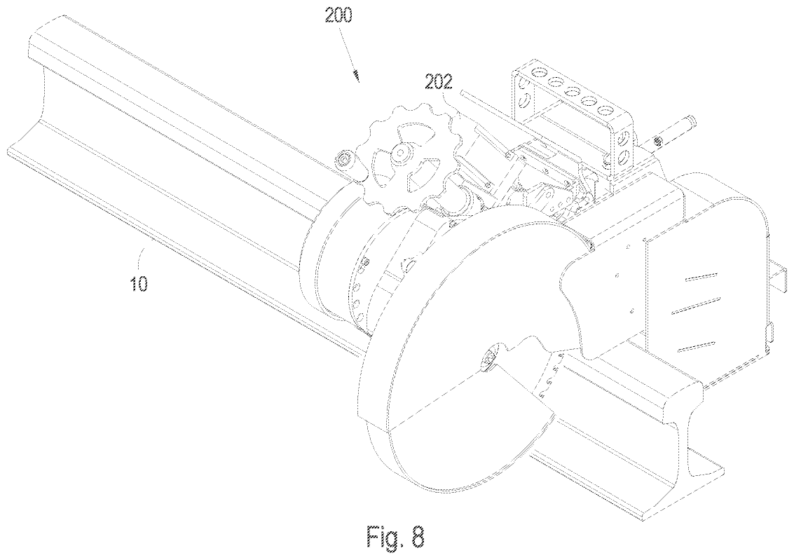

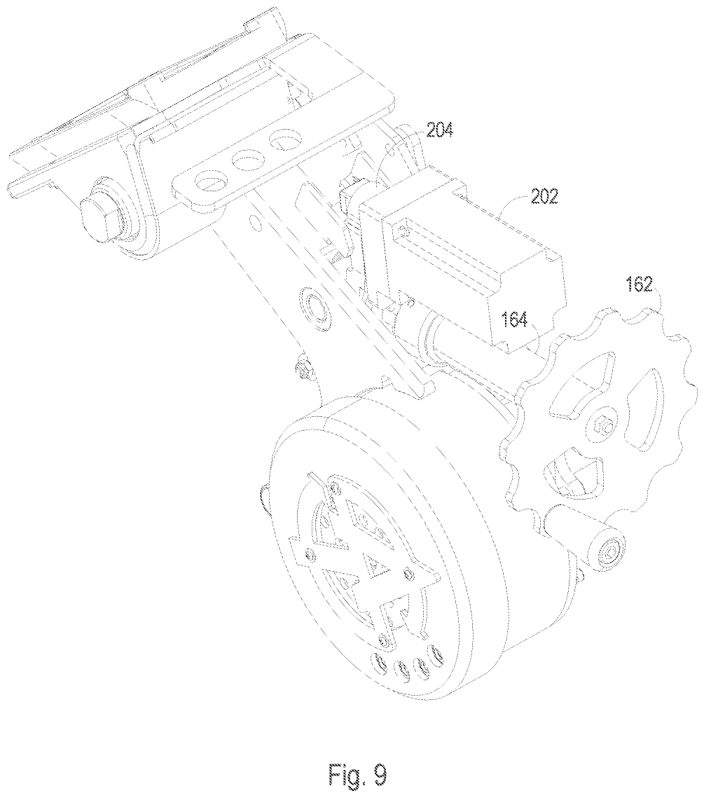

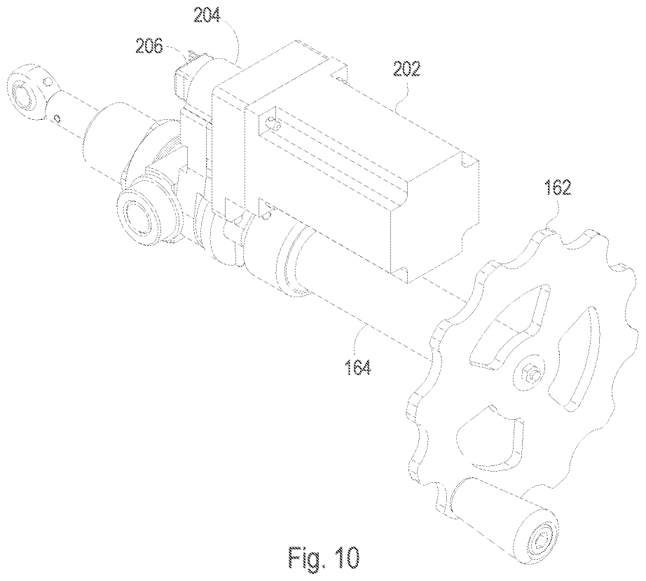

FIGS. 8-14 illustrate a second embodiment of a two-part rail saw assembly 200, in accordance with the invention. This version of the rail saw assembly 200 may look slightly cosmetically different from the first version of the rail saw assembly 100 but nonetheless incorporates most or all of the same features. However, this second version of the rail saw assembly 200 includes a notable additional feature: remote feed.

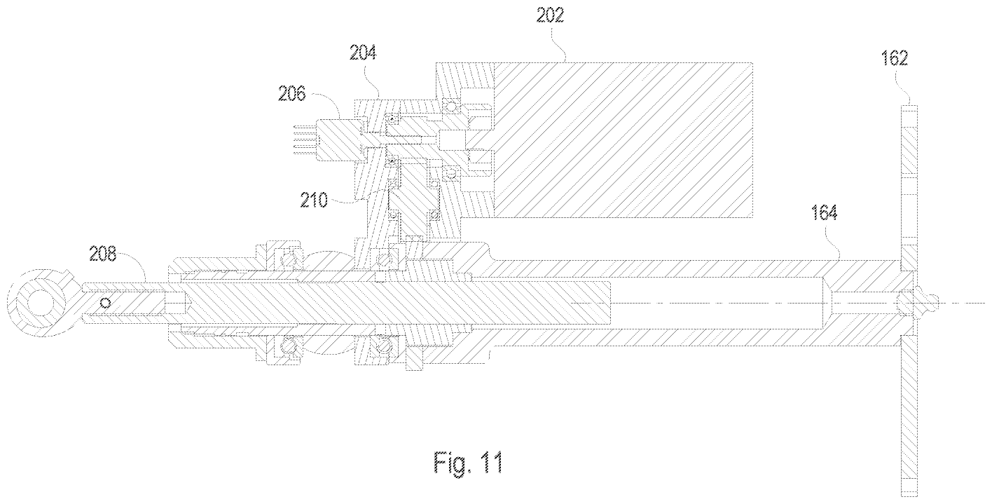

The rail saw assembly 200 has a motor 202 attached, via a motor mounting guide 204, to the feed mechanism 160. More specifically, the motor 202 is drivingly coupled via a transmission mechanism (e.g., a reduction gearbox 210, see FIG. 11) to the feed shaft assembly 164. The motor 202 may be detachable from the remainder of the saw part 104, e.g., to preserve the weight of the assembly 200 to below 25 kg during transport

The motor 202 may be a stepper motor. The motor 202 is controlled by a control module (not illustrated), e.g., housed within the motor mounting guide 204, which is configured to receive a user command from the user and to translate that user command to a control signal which is communicated to the motor 202 to control the motor 202. In this example, the control module is coupled to a wireless communication arrangement which is configured to receive one or more wireless user commands from the user or operator (and may also be configured to send operational data back to the user).

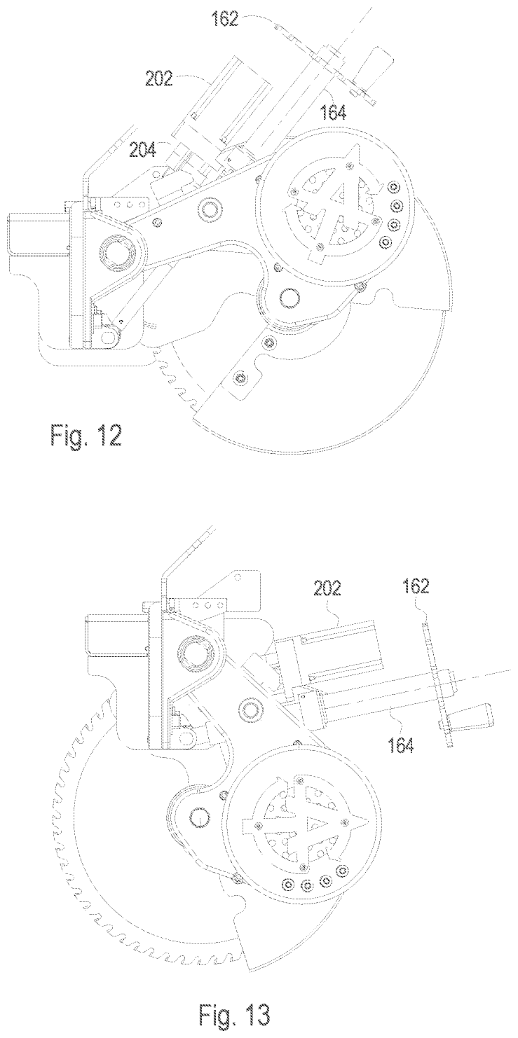

As described above, the angle of the feed mechanism 160 changes throughout the cutting arc. Accordingly, as the motor 202 is mounted to the feed shaft assembly 162, the motor 202 travels with the saw blade 150 along the cutting arc, and always retains a parallel orientation to a longitudinal axis of the feed shaft assembly 162. This is illustrated in the contrast between FIG. 12 (retracted position) and FIG. 13 (extended or engaged position). The motor 202 is prevented from rotating about the longitudinal axis of the motor mounting guide 204.

The motor 202 is coupled to an internally threaded bush 208 of the feed shaft assembly 162 via the reduction gearbox 210 (see FIG. 11). An input gear of the reduction gearbox 210 is coupled to a rotary encoder 206 to allow: (1) speed/position of the motor 202 to be monitored; and (2) manual input from the manual feed actuator 162 to be recorded (e.g., during manual feed).

The control module is also coupled to speed and load (current/pressure) sensors on the saw motor contained in the saw hub 152 and is able to turn the saw motor on/off via a motor control circuit. The rail saw assembly 200 may be fitted with limit switches in the upper and lower positions of travel, and these are also connected to the control module. The entire feed system, including the motor 202 and the control module, may be battery powered. The sensors placed on the saw motor allow the processor to sense the amount of power being drawn by the saw by measuring shaft speed and current (or pressure, depending on whether a hydraulic or electric motor is used). The limit stops give absolute positioning data to the control module. The shaft encoder 206 gives feed rate and relative position data. This allows for either open or closed loop control of the feed to be implemented.

It was be noted that the motor 202 causes the same action as turning the feed actuator 162 by hand; one option (the feed actuator 162) is manual and the other (the motor 202) is automatic or remotely actuatable.

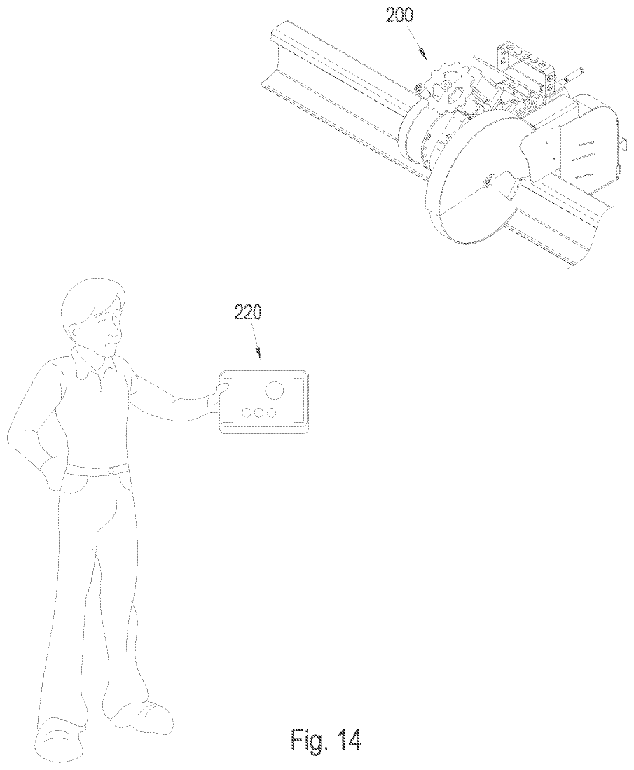

The wireless communication arrangement is configured to receive the wireless user commands from a remote controller 220 (see FIG. 14). This could be a bespoke device, configured only to interact with the rail saw assembly 200, or could be a more general device (e.g., a paired mobile phone). The wireless communication may be by Bluetooth, WiFi direct, etc. The remote controller 220 includes various UI (User Interface) elements, like buttons, sliders, or dials, to provide input to the motor 202 via the wireless communication arrangement. The UI may also include various data input fields with which the operator may provide more precise input.

Four types of control regimes are envisaged.

### 1. Direct Manual Feed

This is incorporated as a redundant backup in case the remote feed or auto-feed system malfunctions. This is the only option for the first rail saw assembly 100 but one of a plurality of options for the second rail saw assembly 200. In this regime, the operator can remove the feed motor 202 from the feed mechanism 160 and control the saw 150 entirely using the manual handwheel 162. The encoder 206 fitted to the feed mechanism 160 optionally senses the input of the operator in this control scheme (described above).

### 2. Remote Manual Feed

The operator controls the feed manually using a UI component (e.g., a jog wheel) on the remote controller 220. The operator's movement of the jog wheel is translated directly into movement of the hand wheel 162 via the motor 202. This allows the operator to maintain complete and precise control of the saw 150 from a safe distance without having to physically contact the hand wheel 162. The operator is also able to turn the saw cutting motor on an off.

### 3. Pre-Programmed Feed

A feed motor position and speed profile is stored, the operator selects the profile. Once selected, the feed motor 202 enacts the saved profile. In the event of a blade jam, the saw 150 disengages and then re-engages slowly, it then resumes the recorded cut profile but reduces the feed rate by a scaling factor to prevent future stalling. Programs for common rail profiles will be included standard with rail saw assembly 200, but the operator also has the option to generate new cut profiles by manually cutting a rail section either using control regime 1 or 2 above. The movement of the feed screw 208 is recorded by the encoder 206 and saved as a motor profile—which can then be called back by the operator at a later stage.

### 4. QuickSplit Auto Feed

This allows the operator to cut any rail profile at the press of a button. The operator positions the saw 150 in the vicinity of the rail 10 either using control regime 1 or 2. The operator then engages the Quicksplit Auto Feed feature. The saw motor turns on and initially cuts slowly at a fixed low feed rate for a set time period (e.g., 10 s) to bed the blade 150 and then cuts through the rail 10 as quickly as possible (within the bounds of a maximum permitted feed rate) using closed loop control to modulate feed rate to achieve a maximum allowable motor power draw. In the event of a jam, the saw 150 disengages briefly and then re-engages slowly for a set period (e.g., 5 s) and then re-commences closed loop control. Each time the saw jams, the maximum allowable power is reduced by a scaling factor. At the end of the cut (either when the lower limit stop is triggered, or when the processor senses that there is no load on the motor for an extended period)—the cutting motor is turned off, and the saw retracts until it contacts the top limit stop.

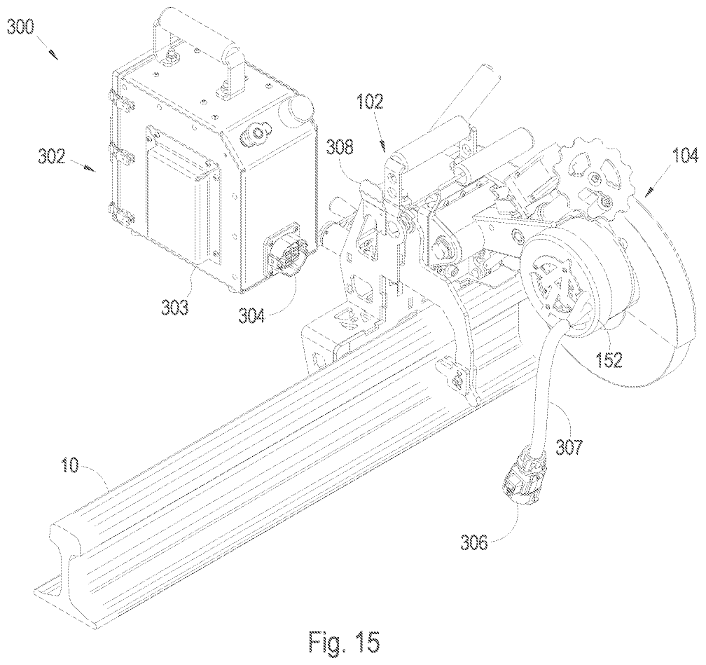

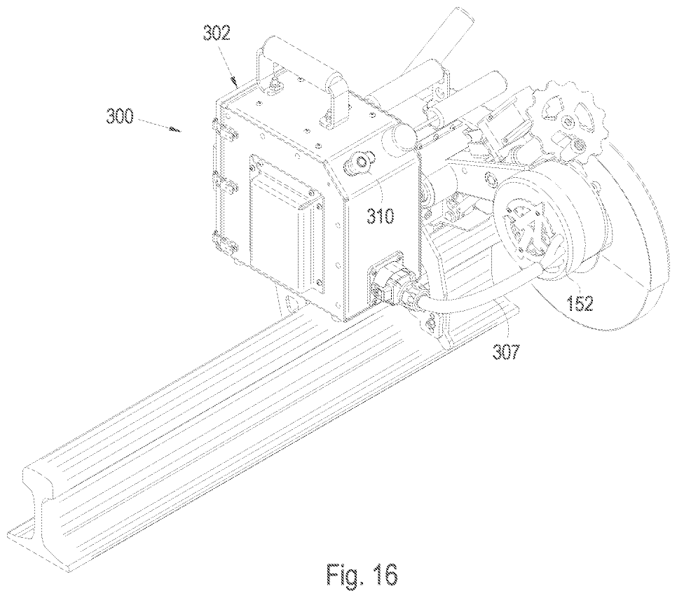

FIGS. 15-16 show a third embodiment of a rail saw assembly 300 in accordance with the invention. This third embodiment includes most or all of the features of previous embodiments (that is, the saw assemblies 100, 200) but also includes a battery part 302 comprising a housing 303 containing a battery (which may be a lithium battery).

The housing 303 defines a power outlet socket 304. The hub 152 of the saw part 104 has a power cable 307 connected to the hub 152 containing the electric motor to drive the saw blade 150. The power cable 307 terminates in a plug 306 complemental to the socket 304.

The clamp part 102 defines a mounting formation 308 configured to mate with a complemental formation (not illustrated) on the housing 303 of the battery part 302 thereby to mount the battery part 302 mechanically and securely to the clamp part 102. The power cable 307 serves to interconnect the battery part 302 electrically with the saw part 104.

FIG. 16 illustrates the three parts 102, 104, 302 connected to one another. The battery part 302 has an input interface 310 which, in this embodiment, includes a basic on/off switch and a dial which may control battery output or saw speed, etc. The input interface 310 may also include an indicator(s), e.g., to indicate (remaining) battery capacity, saw speed, error conditions, etc.

Although FIGS. 15-16 illustrate the battery part 302 (housing the battery) as a separate part, in other embodiments (not illustrated), the battery may be integrated with either the clamp part 102 or the saw part 104. It might be necessary or desirable, to keep weight of individual parts down or below a threshold, to have three separate parts 102, 104, 302. Also, having a separate battery part 302 may permit this part to be swapped out for a fresh battery when the old battery is discharged. However, as battery power densities increase and their weight decreases (especially with the advancement of lithium and other battery technologies), it may become practicable or desirable not to have a separate third part 302.

The invention as exemplified is technically beneficial in that it provides the following advantages:
The assembly 100 is separable into two parts 102, 104, so each part 102, 104 may be lighter than a single unit would be. This makes for easier handling as each part 102, 104 may weigh less than 25 kg.
The interconnection arrangement 120, 140 is precise, rigid, and fixed. It self-aligns so no guesswork is required from the user.
The displacement/feeding of the saw blade 150 is enabled by a pivoted connection 158 between the saw arm 156 and the second connection interface 140, not by a pivoted or sliding connection between the two interfaces 120, 140 themselves (as may be the case with some grinding cutters conventionally used to cut rails).
Feeding of the saw blade 150 is controlled by a feed mechanism 160 which works very differently from, for example, grinding or abrasive cutting. The feeding is along a single feed path and is slow and very controlled. Such feed characteristics are beneficial or required for a TCT saw blade but may be discouraged for a grinding cutter. The feed mechanism may be tensioned to a set force during assembly—this removes any float.
Telescoping parts of the feed shaft assembly 164 may be completely enclosed, preventing shavings from contaminating it (otherwise, shavings could damage the thread, causing float). In a future development, the applicant envisages that a feed force from the feed mechanism could be even more precisely controlled, e.g., using a torquing arrangement.
The shavings collection tray 138 is configured to collect the shavings, assisted by the saw guard 154, and can be emptied when required by the operator.
The clamping force (applied via the clamp actuator 132) may be predictable and repeatable due to a load limiter in the clamp mechanism which gives an audible “click” to the user when the appropriate tension is achieved.
As cutting is more precise, a duty cycle/limit for the saw blade 150 may be defined, and deflection may be measured within the bounds of this duty cycle.
If necessary, accuracy may be imposed on the saw blade 150 by means of an “adjustment factor”; this may allow accurate cuts within a ±1.5 mm tolerance to be achieved. Effectively, the frame may be purposefully manufactured with a “skew” element which counteracts the various unavoidable elastic deflections that occur during use. A superposition of the adjustment factor and the elastic deflection may result in a perfectly straight cut. Adjustment may be achieved by lengthening or shortening one of the clamping jaws (during manufacture), to rotate the position of the saw on the rail.
The first assembly 100 may be designed such that there is an unbroken chain of precisely manufactured, and rigidly assembled components which starts at the clamping jaws (130) and ends at the saw blade (150) (despite there being a non-permanent connection).
The second assembly 200 includes some or all of the advantages of the first, but additionally provides the remote or automatic feeding. This may have safety, repeatability, and/or convenience advantages.

What is claimed is:

1. A two-part rail saw assembly which includes:
a clamp part including:
a clamp mechanism configured to clamp to a rail to be cut; and
a first connection interface coupled to the clamp mechanism; and
a saw part including:
a second connection interface complemental to the first connection interface, the first and second connection interfaces configured to fixedly and positively interconnect, thereby to connect and fix the saw part relative to the clamp part;
a circular saw blade rotatably mounted to a saw hub, the saw hub being displaceably mounted relative to the second connection interface; and
a feed mechanism configured to guide and displace the saw hub, and hence the saw blade, through a cutting path relative to the second connection interface, and thus relative to the clamp part when the parts are interconnected, and thus relative to the rail when the clamp mechanism is clamped thereto.

2. The rail saw assembly as claimed in claim 1, in which the saw hub is mounted to the second connection interface via a saw arm.

3. The rail saw assembly as claimed in claim 2, in which the saw arm is mounted at one end to the saw hub and hingedly mounted at the other end to a part of the second connection interface.

4. The rail saw assembly as claimed in claim 3, in which the feed mechanism interconnects (1) the saw hub or saw arm and (2) the second connection interface.

5. The rail saw assembly as claimed in claim 4, in which the feed mechanism is hingedly connected to the second connection interface and in which the hinged connections of the feed mechanism and the saw arm to the second connection interface are transversely offset, or not co-axial.

6. The rail saw assembly as claimed in any one of claims 1-5, in which:
the feed mechanism includes a threaded feed shaft co-operable with a threaded channel, socket, or bush on the saw hub or saw arm; and
rotating the feed shaft of the feed mechanism causes the saw hub to travel linearly along the feed shaft and correspondingly to be displaced along the cutting path.

7. The rail saw assembly as claimed in any one of claims 1-6, in which the feed mechanism includes an actuator.

8. The rail saw assembly as claimed in claim 7, in which the actuator is a manual, hand-operable actuator.

9. The rail saw assembly as claimed in any one of claims 7-8, in which the feed mechanism is automated and comprises a motor.

10. The rail saw assembly as claimed in claim 9, in which the feed mechanism includes a control module to provide a control signal to the motor to actuate the motor, the control module being configured to generate the control signal in response to receipt of a user command.

11. The rail saw assembly as claimed in claim 10, in which the feed mechanism includes a communication arrangement configured to receive the user command from a remote device.

12. The rail saw assembly as claimed in claim 11, in which the communication arrangement is a wireless communication arrangement and is configured to receive the user command from a mobile or portable electronic device.

13. The rail saw assembly as claimed in any one of claims 1-12, in which:
the connection interfaces are configured for a sliding interconnection; and
the connection interfaces include complemental sliding formations.

14. The rail saw assembly as claimed in any one of claims 1-13, in which the connection interfaces define a locking formation, to prevent sliding and lock the connection interfaces together.

15. The rail saw assembly as claimed in any one of claims 1-14, in which the connection interfaces include a mechanical compression formation configured to urge, compress, or force the connection interfaces into locked and rigid engagement.

16. The rail saw assembly as claimed in any one of claims 1-15, which includes:
an electric motor drivingly connected to the saw blade; and
a battery configured to be connected to the electric motor thereby to drive the saw blade.

17. The rail saw assembly as claimed in claim 16, in which the battery is integrated with either the clamp part or the saw part.

18. The rail saw assembly as claimed in claim 16, in which the rail saw assembly includes a third part, namely a battery part, which comprises the battery and which is configured to be mechanically attached to either the clamp part or the saw part and electrically connected to the electric motor.

19. The rail saw assembly as claimed in claim 18, in which:
the battery part and the clamp part define complemental mounting formations for mechanical attachment of the battery part to the clamp part; and
the battery part and the saw part define complemental electrical connection formations for electrical connection of the battery part to the saw part.
